(19) United States
(12) Patent Application Publication
(10) Pub. No.: US 2014/0363989 A1
(43) Pub. Date: Dec. 11, 2014

(54) CONNECTOR ASSEMBLY

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: LONG-JUAN WANG, Shenzhen (CN); YA-NI ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/187,355

(22) Filed: Feb. 24, 2014

(30) Foreign Application Priority Data
Jun. 11, 2013 (CN) 2013102302355

(51) Int. Cl. H01R 13/627

(52) U.S. Cl. CPC H01R 13/6275
USPC 439/55

(57) ABSTRACT

A connector assembly includes a circuit board, a socket attached to the circuit board, and a mounting tray. The mounting tray includes a clipping portion and a clamping arm. The clipping portion is clipped to the circuit board and the socket, to secure the mounting tray to the circuit board and the socket. The clamping arm is deformable to clamp a plug in the socket.

### FIELD

The present disclosure relates to connector assemblies, and particularly to a connector assembly in a computer.

### BACKGROUND

Connectors are used to electronically connect a first object to a second object. A connector includes a socket. A plug is often engaged in the socket. However, some plugs are often unstably connected to the corresponding sockets, so the plugs easily disengage from the sockets.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a connector assembly in accordance with an embodiment.

FIG. 2 is similar to FIG. 1, but viewed from a different aspect.

FIG. 3 is similar to FIG. 1, but a mounting tray is secured to a circuit board of the connector assembly of FIG. 1.

FIG. 4 is an assembled view of the connector assembly of FIG. 1.

FIG. 5 is similar to FIG. 1, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

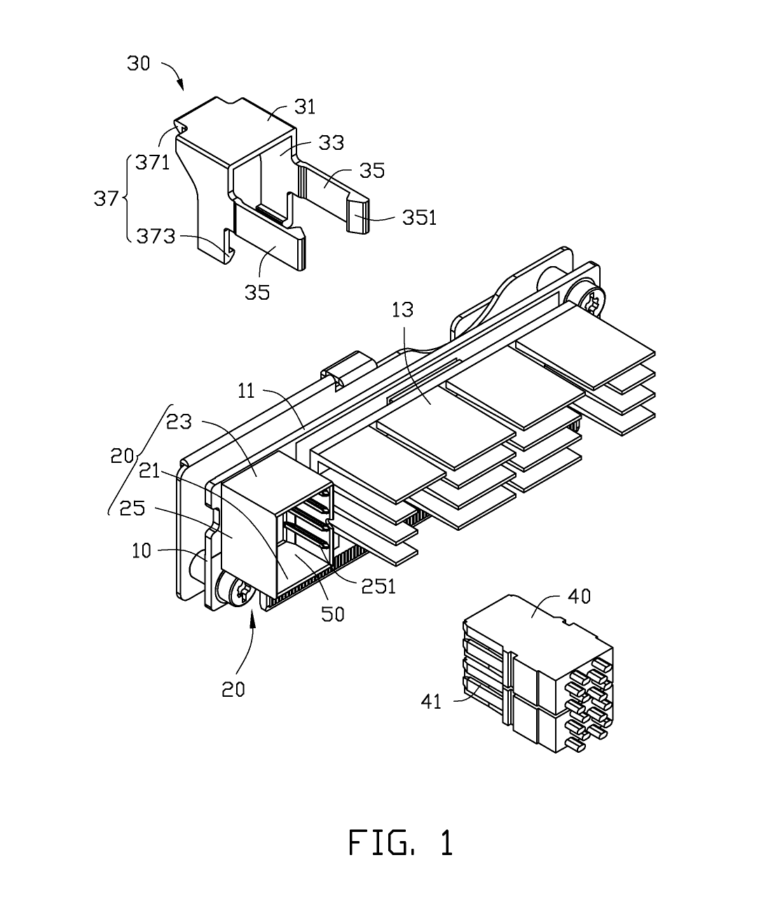

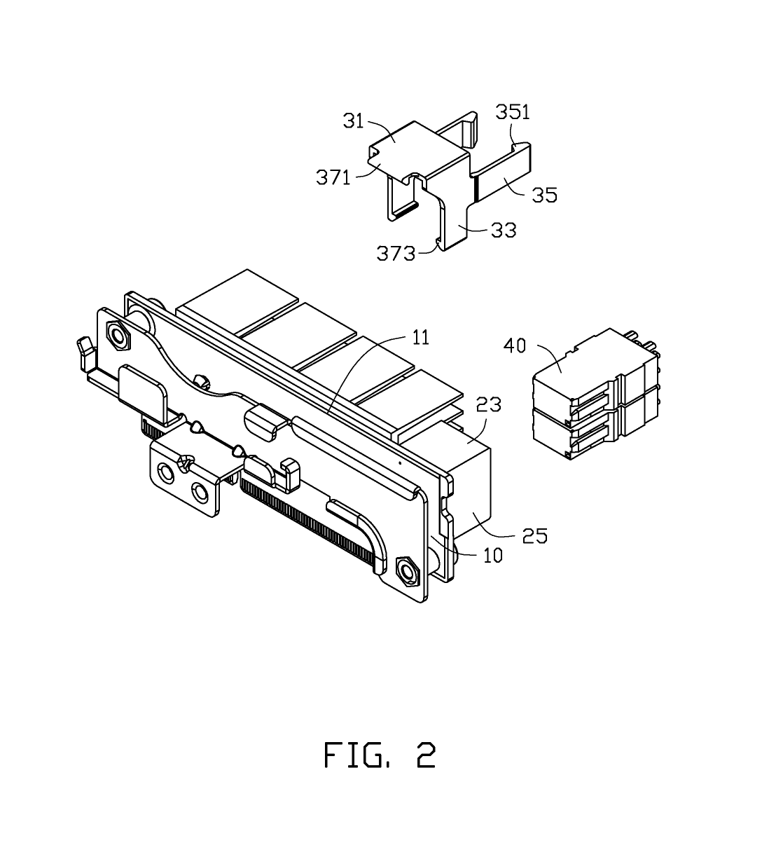

FIGS. 1-2 illustrate a connector assembly in accordance with an embodiment. The connector assembly comprises a circuit board 10, a socket 20 secured to the circuit board 10, a mounting tray 30, and a plug 40. The plug 40 comprises two inserting portions 41 that are located on opposite sides of the plug 40.

The circuit board 10 comprises a top edge 11. A heat sink 13, with a plurality of fins is connected to the circuit board 10.

The socket 20 comprises a bottom panel 21, a top panel 23, and two side panels 25 connected to the bottom panel 21 and the top panel 23. In one embodiment, the top panel 23 is substantially parallel to the bottom panel 21 and perpendicular to the circuit board 10. The top panel 23 is adjacent to the top edge 11. A plurality of pins 251, correspond to the inserting portion 41, are located in an inner surface of each side panel 25. The bottom panel 21, the top panel 23, and the two side panels 25 cooperatively define a receiving space 50 for receiving the plug 40.

The mounting tray 30 comprises a top plate 31, two side plates 33 extending from the top plate 31, and two clamping arms 35. In one embodiment, each side plate 33 is substantially perpendicular to the each clamping arm 35 and the top plate 31. The mounting tray 30 comprises a clipping portion 37. The clipping portion 37 comprises a first hook 371 and two second hooks 373. The first hook 371 extends from the top plate 31. Each second hook 373 extends from each side plate 33. Each clamping arm 35 extends from each side plate 33 and comprises a third hook 351 for clipping the plug 40. In one embodiment, the two side plates 33 and the two clamping arms 35 are deformable.

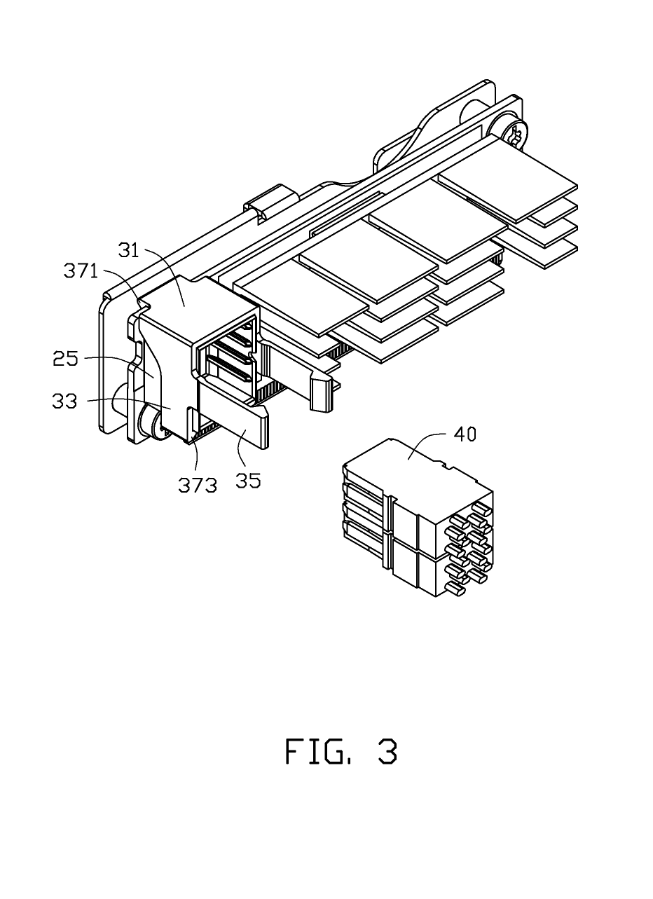

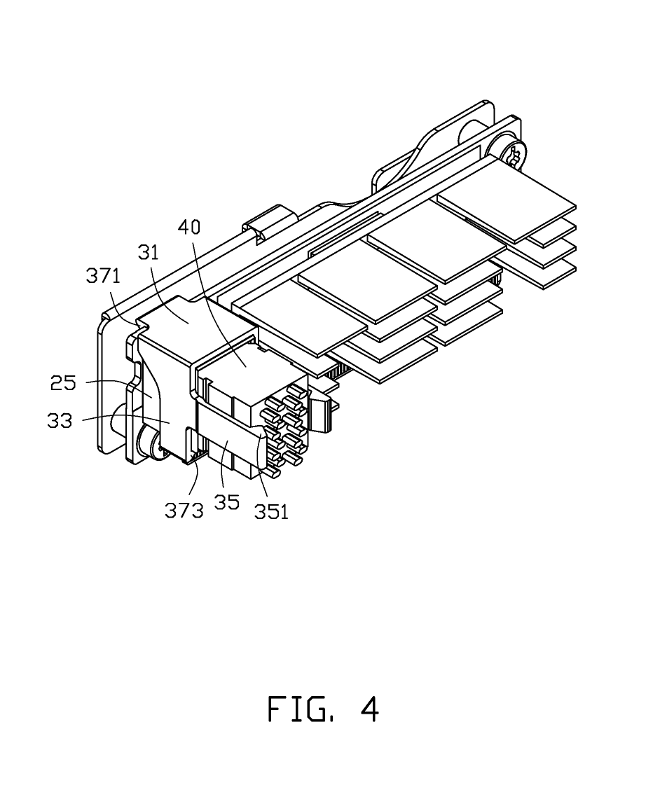

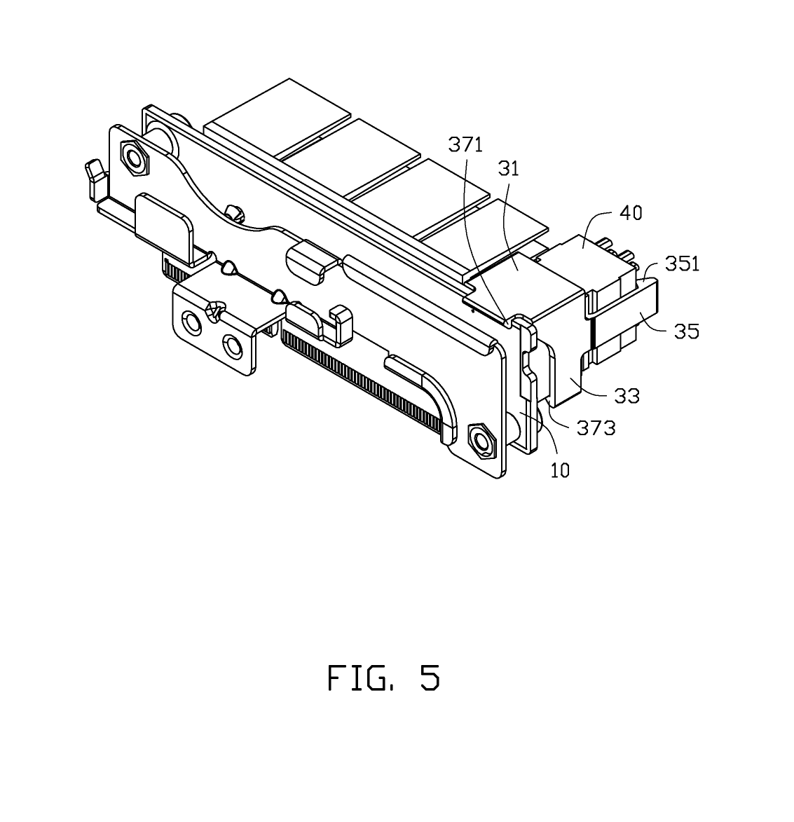

FIGS. 3-5 illustrate that in assembly of the connector assembly, the mounting tray 30 is above the top edge 11. The mounting tray 30 is moved in a first direction that is substantially perpendicular to the top panel 23, until the two second hooks 373 respectively abut two opposite edges of the top panel 23,. The mounting tray 30 is further moved in the first direction, and each side plate 33 is deformed away from each side panel 25. Each second hook 373 is moved along each side panel 25, until each second hook 373 is engaged with a bottom panel 21. At this time, the first hook 371 is clipped with the edge 11, the top plate 31 abuts the top panel 23, and each side plate 33 abuts each side panel 25. Each clamping arm 35 extends out of the socket 20, and the mounting tray 30 is thus secured to the socket 20.

The plug 40 is moved in a second direction that is substantially perpendicular to the first direction, until the third hooks 351 are engaged with the plug 40. The plug 40 is further moved in the second direction, each clamping arm 35 deforms away from the plug 40. The third hooks 351 are slid along the plug 40, until the third hooks 351 clips the plug 40. The inserting portions 41 are engaged with the plurality of pins 251, and the plug 40 is received in the receiving space 50.

In disassembly of the plug 40 from the socket 20, each clamping arm 35 is deform away from the plug 40 to disengage from the plug 40. The plug 40 is pulled in a third direction that is opposite to the second direction, the inserting portions 41 are disengaged from the plurality of pins 251, and the plug 40 can be removed from the socket 20.

In disassembly of the mounting tray 30, each side plate 33 is deform away from each side panel 25, so that each second hook 373 is disengaged from the bottom panel 21. The mounting tray 30 is moved in a fourth direction that is opposite to the first direction. The first hook 371 is removed from the top edge 11. The mounting tray 30 is further moved in the fourth direction, and the mounting tray 30 can be disengaged from the circuit board 10.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A connector assembly comprising:
a circuit board;
a socket attached to the circuit board; and
a mounting tray comprising a clipping portion and a clamping arm;
wherein the clipping portion is clipped to the circuit board and the socket, to secure the mounting tray to the circuit board and the socket, and the clamping arm is deformable to clamp a plug in the socket.

2. The connector assembly of claim 1, wherein the socket comprises a top panel, the mounting tray comprises a top plate abutting the top panel, the clipping portion comprises a first hook extending from the top plate, and the first hook is clipped to the circuit board.

3. The connector assembly of claim 2, wherein the circuit board comprises a top edge, the mounting tray is moveable in a direction that is substantially parallel to the circuit board, to engage the first hook with the top edge.

4. The connector assembly of claim 2, wherein the top panel is substantially perpendicular to the circuit board.

5. The connector assembly of claim 2, wherein the socket further comprises a bottom panel that is substantially parallel to the top panel, and the clipping portion further comprises a second hook clipped with the bottom panel.

6. The connector assembly of claim 5, wherein the socket further comprises a side panel that is substantially perpendicular to the bottom panel, and the second hook extends from the side panel.

7. The connector assembly of claim 6, wherein a plurality of pins is located on an inner surface of the side panel, and the plurality of pins is configured to be connected to the plug.

8. The connector assembly of claim 1, wherein the mounting tray comprises a side plate, the clamping arm extends from the side plate and comprises a third hook, and the third hook is configured to clip the plug when the plug is inserted in the socket.

9. A connector assembly comprising:
a circuit board;
a socket attached to the circuit board; and
a mounting tray comprising a clipping portion and a clamping arm; the clipping portion comprising a first hook and a second hook;
wherein the first hook is clipped with the circuit board, to prevent the mounting tray from moving in a first direction, the second hook is clipped with the socket, to prevent the mounting tray from moving in a second opposite direction, and the clamping arm is deformable to clamp a plug in the socket.

10. The connector assembly of claim 9, wherein the socket comprises a top panel, the mounting tray comprises a top plate abutting the top panel, and the first hook extends from the top plate.

11. The connector assembly of claim 10, wherein the circuit board comprises a top edge, the mounting tray is moveable in a direction that is substantially parallel to the circuit board, to engage the first hook with the top edge.

12. The connector assembly of claim 10, wherein the top panel is substantially perpendicular to the circuit board.

13. The connector assembly of claim 10, wherein the socket further comprises a bottom panel that is substantially parallel to the top panel, and the second hook is clipped to the bottom panel.

14. The connector assembly of claim 13, wherein the socket further comprises a side panel that is substantially perpendicular to the bottom panel, and the second hook extends from the side panel.

15. The connector assembly of claim 14, wherein a plurality of pins is located on an inner surface of the side panel, and the plurality of pins is configured to connected to the plug.

16. The connector assembly of claim 9, wherein the mounting tray comprises a side plate, the clamping arm extends from the side plate and comprises a third hook, and the third hook is configured to clip with the plug when the plug is inserted in the socket.
